(19) United States
(12) Patent Application Publication
(10) Pub. No.: US 2010/0163530 A1
(43) Pub. Date: Jul. 1, 2010

(54) Dual Dual Welder

(76) Inventors: James Harvey, Cleveland, OK (US); Gary Pearce, Chelsea, OK (US)

Correspondence Address: GABLE & GOTWALS, 100 WEST FIFTH STREET, 10TH FLOOR, TULSA, OK, 74103, US

(21) Appl. No.: 12/030,716

(22) Filed: Feb. 13, 2008

(51) Int. Cl. B23K 9/18; B23K 28/00

(52) U.S. Cl. 219/73; 219/148

(57) ABSTRACT

An apparatus and method to create a plurality of parallel joints by providing a carriage which traverses along the joints. The carriage has two or more welding tips for each joint. Alignment of the welding tips with the joints is maintained by rollers secured to the carriage. These rollers traverse along the surfaces of the work piece. The work pieces are secured on a pair of turntables having a common access of rotation which is parallel with the joints. The joints in both the top and bottom of the header can be created by rotating the work pieces in to the bottom side once the welds in the topside have been completed.

### REFERENCE TO PENDING APPLICATIONS

This application is not based upon any pending domestic or international patent applications.

### REFERENCE TO MICROFICHE APPENDIX

This application is not referenced in any microfiche appendix.

### FIELD OF THE INVENTION

The present invention relates generally to an automated welding apparatus and method used to simultaneously create two or more parallel joints. More specifically, the present invention involves an apparatus and method wherein each of these parallel joints, two or more welding tips work simultaneously on each joint.

### BACKGROUND OF THE INVENTION

In the metal fabrication business it is common to manufacture items which have two or more long parallel joints. One such example is a header used in a heat exchanger. A header is generally a hollow elongated box constructed out of flat steel plates. In the final assembly a header is usually constructed out of four work pieces without including the end plates (not addressed by this patent as not applicable). The center body portion typically has a form of a rectangular frame with an opposing top and bottom, called wrappers, welded to two opposing side pieces, called a tube and plug sheet. The tube sheet and the plug sheet are welded onto opposing sides of the center body, separated by the wrappers. Because of the thickness of the steel used the welds between the tube and plug sheets and the body require an extremely large weld. This means a significant amount of weld material must be deposited into the joints.

In the past the creation of these joints has taken significant amount of labor due to the large cross-sectional area and the length of the weld.

In an attempt to reduce the amount of labor involved in fabricating these large parallel welds, the prior art shows numerous devices capable of creating parallel welds by simultaneously using one welding tip on each weld.

Other devices found in the prior art address the issue of creating one individual large joint by simultaneously welding on the same joint with two welding tips.

While both of these types of prior art provide an improvement over creating the joints by having to individually manually weld them further improvements in the art is needed.

### BRIEF SUMMARY OF THE INVENTION

The present invention involves an apparatus and method to create a plurality of parallel joints by providing a carriage which traverses along the welds. The carriage has two or more welding tips for each joint. Alignment of the welding tips with the joints is maintained by rollers secured to the carriage. These rollers traverse along the surfaces of the work piece.

Productivity can further be improved by securing the work pieces on a pair of turntables having a common axis of rotation. This access of rotation is also parallel with the joints.

With the work pieces mounted in the turntables the welds in both the top and bottom of the header can be created by simply rotating the work pieces to the bottom side once the welds on the top side have been completed.

Further objects and features of the present invention will be apparent to those skilled in the art upon reference to the accompanying drawings and upon reading the following description of the preferred embodiments.

### BRIEF DESCRIPTION OF THE DRAWINGS

FIG. 1 shows a perspective view of one embodiment of the present invention.

FIG. 2 shows a close up perspective view of the carriage and welding tips while creating two parallel joints.

### DETAILED DESCRIPTION OF THE PREFERRED EMBODIMENTS

For explaining the present invention in detail it is to be understood that the invention is not limited in its application to the details of the construction and arrangement of the parts illustrated in the accompanying drawings. The invention is capable of other embodiments and of being practiced or carried out in a variety of ways. It is to be understood that the phraseology and terminology employed herein are for the purpose of description and not of limitation.

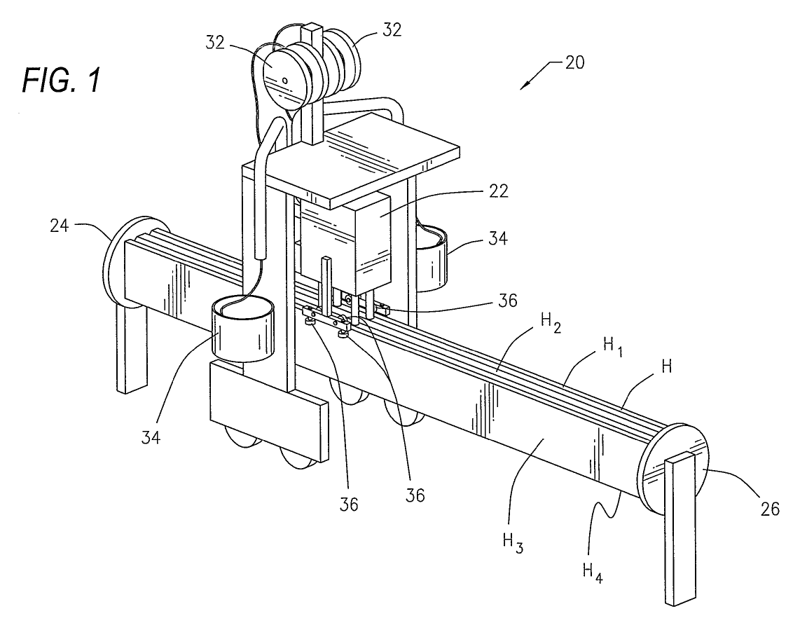

Turning to FIG. 1, the welding machine 20 of the present invention 20 has a carriage 22. The welding machine 20 has a first and second turntable 24 and 26 holding a header H which the header is comprised of four pieces H₁, H₂, H₃ and H₄ (H₄ is opposite H₂). The first piece of the header H₁ is welded to H₂ by a weld W₁ which is located in joint J₁. The third piece of the header H₃ is simultaneously welded to the second piece of the header H₂ by a second weld W₂ located in joint J₂. The first and second weld W₁ and W₂ are generally linear and run parallel with one another. The carriage 22 has a first pair of welding tips 28 each of these first pair of welding tips 28 are aligned with one of the welds W₁ and W₂. The carriage 22 has a second pair of welding tips 30. Each of the welding tips of the second pair 30 are aligned with one of the parallel welds W₁, W₂. The welding tips 28 and 30 can be of varying types such as alternating current or AC welders or direct current otherwise known as DC welders. Likewise the present invention involves the use of submerged arc welders (SAW).

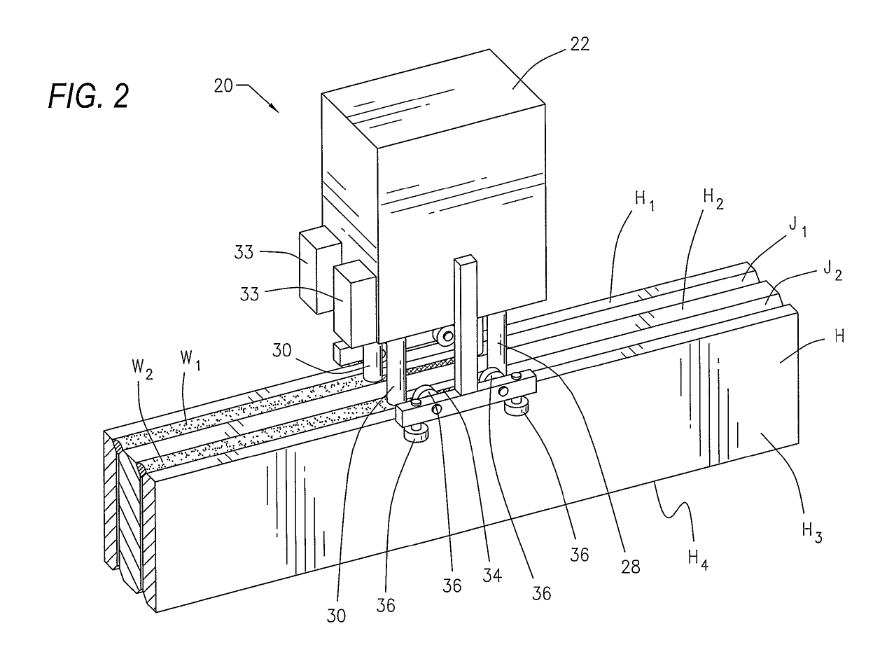

The preferred embodiment of the invention as shown in FIGS. 1 and 2 uses submerged arc welders for the first pair of welding tips 28. This is a direct current type of welding. The second pair of welding tips 30 are SAW welders which utilize an alternating current. The welding wire for the first pair 28 is provided by a pair of spools 32, which as shown can be mounted on top of the invention or next to spools 34. The weld wire for the submerged arc welding is provided by a second pair of spools 34. As part of the submerged arc welding a bed of granular flux 33 is laid into the joints J₁ and J₂ next to the first pair of welding tips 28.

In the preferred embodiment the spacing between the first welding tip 28 and the second welding tip 30 is approximately 1.25 inches. It is also beneficial to have the second welding tip 30 angled 12 degrees off of vertical such that the second welding tip 30 points toward the first welding tip 28. Likewise it is beneficial to run the second welding tip 30 approximately 100 amps hotter than the first welding tip 28. The higher amperage of the second welding tip 30 ensures a high quality weld by burning the liquid slag out of the weld pool. Weld penetration can be enhanced by using a smaller diameter wire or electrode on the first welding tip. This ensures the weld reaches the bottom of the joint. Further, deposit rates can be improved by having a larger diameter wire or electrode on the second welding tip 30

In the process of the preferred embodiment the three pieces of the header H₁, H₂ and H₃ are mounted in the first and second turntable 24 and 26. The carriage 22 of the welding machine 20 is located at a first end of the header H such that one of each of the first pair of welding tips 28 is aligned with each of the joints J₁ and J₂. Likewise one of each of the second pair of welding tips 30 is also aligned with each of the joints J₁ and J₂. The carriage 22 is then traversed from the first end of the header H towards the second end of the header H. As the carriage 22 traverses the header H, the first and second pair of welding tips 28 and 30 are maintained in alignment with the joint J₁ and J₂ by one or more rollers 36. The rollers 36 contact various surfaces of the header H as the carriage 22 traverses the header H. One or more lasers could be used to guide the carriage 22 in lieu of the rollers.

The first pair of welders 28 join together the parts of the header H₁, H₂ and H₃ using a direct current welding process. Adjacent to the first pair of welder 28 a layer of granular flux is laid into the joints J₁ and J₂. The second pair of welding tips 30 carry out an alternating current welding process. The direct current welding process and the alternating current welding process create welds W₁ and W₂ in the joints J₁ and J₂ respectfully.

When the carriage 22 reaches the second end of the header H the first and second welding tips 28 and 30 are disengaged. The carriage 22 is then traversed back to the first end of the header H. The header H is then rotated in the first and second turntables 24 and 26 along the longitudinal axis such that what had previously been the bottom of header H is now the top. The carriage 22 and first and second pair of welding tips 28 and 30 are then aligned so that the welding machine 20 can be used to weld together the bottom side of the three parts of the header H₁, H₄ and H₃ in the same manner as on the top side of the header H.

It should be noted that the present invention could be adapted with additional welding guns such that it could operate on more than two parallel joints to create more than two welds with the carriage having a first and second welding tip for each additional weld. This would be useful in fabricating equipment with more than two parallel linear welds.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

What is claimed is:

1. A welding apparatus for welding parallel joints between a plurality of work pieces, said apparatus comprising:
a carrier capable of traversing parallel joints;
a first pair of welding tips each aligned with one of the parallel joints; and
a second pair of welding tips each aligned with one of the parallel joints

2. The welding apparatus according to claim 1, said first pair of welding tips further comprising direct current welders.

3. The welding apparatus according to claim 1, said first pair of welding tips further comprising a submerged arc welders.

4. The welding apparatus according to claim 1, said second pair of welding tips further comprising an alternating current welder.

5. The welding apparatus according to claim 1, said second pair of welding tips further comprising a submerged arc welders.

6. The welding apparatus according to claim 1, said carrier further comprising a plurality of rollers contacting at least one of the work pieces.

7. The welding apparatus according to claim 1, said carrier further comprising one or more lasers to guide said carrier.

8. The welding apparatus according to claim 1, further comprising said first pair of welding tips being spaced approximately 1.25 inches from said second pair of welding tips.

9. The welding apparatus according to claim 1, further comprising said second pair of welding tips having a larger diameter than said first pair of welding tips.

10. The welding apparatus according to claim 1, further comprising said second pair of welding tips being angled 12 degrees from vertical and pointing toward said first pair of welding tips.

11. A method for welding parallel joints between a plurality of work pieces, said method comprising:
providing a carrier;
providing a first welding tip for each joint, the first welding tip being mounted on the carrier;
providing a second welding tip for each joint, the second welding tip being mounted on the carrier;
traversing the carrier and welding tips along parallel joints; and
simultaneously operating the first welding tips and the second welding tips as the carrier and tips traverse along the joint to create parallel welds.

12. The method of claim 11, wherein the first welding tips weld using a direct current.

13. The method of claim 11, wherein the first welding tips weld using a submerged arc welding process.

14. The method of claim 11, wherein the second welding tips weld using an alternating current process.

15. The method of claim 11, wherein the second welding tips weld using a submerged arc welding process.

16. The method of claim 11, further comprising maintaining a proper distance between the welding tips and the work pieces by providing the carrier with one or more rollers which contact one or more of the work pieces as the carrier traverses the parallel joints.

17. The method of claim 11, further comprising operating the second welding tips at approximately 100 amps greater than the first welding tips.

18. The method of claim 11, further comprising angling the second welding tips approximately 12 degrees from vertical and pointing the second welding tips towards the first welding tips.

19. A method for welding parallel joints, said method comprising:
providing a carrier;
providing a first welding tip for each joint, said first welding tip being mounted on the carrier;
providing a second welding tip for each joint, the second welding tip being mounted on the carrier;
spacing the second welding tips approximately 1.25 inches from the first welding tips;
angling the second welding tips approximately 12 degrees from vertical and pointing the second welding tips toward the first welding tips;
traversing the carrier and welding tips along parallel joints; and
simultaneously operating the first welding tips and the second welding tips as the carrier and tips traverse along the joint to create parallel welds;
wherein the first welding tip uses a direct current welding process and the second welding tips use an alternating current welding process and the second welding tips operates at 100 amps greater than the first welding tips.
